(19) United States
(12) Patent Application Publication
(10) Pub. No.: US 2014/0188942 A1
(43) Pub. Date: Jul. 3, 2014

(54) DATA DRIVEN HIERARCHICAL PAGES

(71) Applicant: APPSENSE LIMITED, Warrington (GB)

(72) Inventor: Paul Keith BRANTON, Rochdale (GB)

(73) Assignee: AppSense Limited, Warrington (GB)

(21) Appl. No.: 13/731,444

(22) Filed: Dec. 31, 2012

(51) Int. Cl. G06F 17/30

(52) U.S. Cl. CPC G06F 17/30294
USPC 707/801

(57) ABSTRACT

A method of managing data includes generating a model file containing descriptions of the data, wherein the descriptions of the data in the model file are formatted as a collection of dictionaries, wherein the descriptions of the data are divided into multiple groups that are associated with multiple hierarchical pages, and wherein the multiple groups associated with the multiple hierarchical pages are listed in the model file in a flat structure, and generating a controller file that, when executed by a processor, causes the processor to interpret the model file and present the data in the multiple hierarchical pages to a user, wherein the controller file refers to one of the multiple groups in the model file, wherein the controller file is re-used to interpret the multiple groups in the descriptions of the data and present the data in the multiple hierarchical pages.

### BACKGROUND

Many computer systems and applications have user interfaces. Common user interfaces include configuration screens/pages via which a system or application user can view and/or modify the settings for the system or application. In general, a system or application developer needs to create layouts of the configuration screens/pages and to arrange controls and information within these screens/pages. The system or application developer also typically needs to write the code to link the user interface (UI) controls (e.g., buttons, switches, and sliders, etc.) with the underlying settings, e.g., to handle the retrieval/display/update/storage of the settings. Each individual setting and its corresponding UI control is usually maintained individually. The addition, change, or deletion of a setting and/or its corresponding UI control normally requires creation of new source code or modification of existing source code. This approach can be labor-intensive, time-consuming, and inefficient.

### SUMMARY

In accordance with the disclosed subject matter, systems and methods are described for providing data driven hierarchical pages.

Disclosed subject matter includes, in one aspect, a method of managing data, which includes generating a model file on a non-transitory computer readable medium containing descriptions of the data, wherein the descriptions of the data in the model file are formatted as a collection of dictionaries, wherein the descriptions of the data are divided into multiple groups that are associated with multiple hierarchical pages, and wherein the multiple groups associated with the multiple hierarchical pages are listed in the model file in a flat structure, and generating a controller file on the non-transitory computer readable medium that, when executed by a processor, causes the processor to interpret the model file and present the data in the multiple hierarchical pages to a user, wherein the controller file refers to one of the multiple groups in the model file, wherein the controller file is re-used to interpret the multiple groups in the descriptions of the data and present the data in the multiple hierarchical pages.

In some embodiments, the controller file refers to the one of the multiple groups in the model file by a key.

In some other embodiments, the controller file, when executed by the processor, further causes the processor to handle loading of the data from a storage medium and storing of the data to the storage medium.

In some other embodiments, at least one dictionary in the collection of dictionaries contains a string and an array.

In some other embodiments, the multiple hierarchical pages have at least two levels.

Disclosed subject matter includes, in another aspect, a system for managing data, which includes a model file stored on a non-transitory computer readable medium containing descriptions of the data, wherein the descriptions of the data in the model file are formatted as a collection of dictionaries, wherein the descriptions of the data are divided into multiple groups that are associated with multiple hierarchical pages, and wherein the multiple groups associated with the multiple hierarchical pages are listed in the model file in a flat structure, and a controller file stored on the non-transitory computer readable medium that, when executed by a processor, causes the processor to interpret the model file and present the data in the multiple hierarchical pages to a user, wherein the controller file refers to one of the multiple groups in the model file, wherein the controller file is re-used to interpret the multiple groups in the descriptions of the data and present the data in the multiple hierarchical pages.

In some embodiments, the controller file refers to the one of the multiple groups in the model file by a key.

In some other embodiments, when executed by the processor, further handles loading of the data from a storage medium and storing of the data to the storage medium.

In some other embodiments, the multiple hierarchical pages have at least two levels.

In some other embodiments, at least one dictionary in the collection of dictionaries contains a string and an array.

Disclosed subject matter includes, in yet another aspect, a model file stored on a non-transitory computer readable medium for managing data, which includes descriptions of the data formatted as a collection of dictionaries, wherein the descriptions of the data are divided into multiple groups that are associated with multiple hierarchical pages in at least two levels, wherein the multiple groups associated with the multiple hierarchical pages are listed in a flat structure, and wherein, when interpreted by a controller at runtime, the model file causes the controller to: present the data in the multiple hierarchical pages to a user, and interpret the multiple groups in the descriptions of the data for the multiple hierarchical pages in the at least two levels.

In some embodiments, the controller refers to one of the multiple groups in the model file.

In some other embodiments, at least one dictionary in the collection of dictionaries contains a string and an array.

Disclosed subject matter includes, in yet another aspect, a non-transitory computer readable medium having executable instructions that, when executed by a processor, cause the processor to: load a model file containing descriptions of data, wherein the descriptions of the data in the model file are formatted as a collection of dictionaries, wherein the descriptions of the data are divided into multiple groups that are associated with multiple hierarchical pages, and wherein the multiple groups associated with the multiple hierarchical pages are listed in the model file in a flat structure, and interpret the model file and present the data in the multiple hierarchical pages to a user, wherein the executable instructions refer to one of the multiple groups in the model file, and wherein the executable instructions are re-used to interpret the multiple groups in the model file and present the data in the multiple hierarchical pages.

In some embodiments, the executable instructions refer to the one of the multiple groups in the model file by a key.

In some other embodiments, the executable instructions, when executed by the processor, further cause the processor to store at least a portion of the data in a storage medium.

In some other embodiments, the multiple hierarchical pages have at least two levels.

In some other embodiments, at least one dictionary in the collection of dictionaries contains a string and an array.

Various embodiments of the subject matter disclosed herein can provide one or more of the following capabilities. Systems and methods described herein can help reduce software development and maintenance time/cost, improve efficiency, enhance code re-usability, and improve consistency within an application/system or across multiple applications/systems.

These and other capabilities of embodiments of the invention will be more fully understood after a review of the following figures, detailed description, and claims.

### BRIEF DESCRIPTION OF THE DRAWINGS

FIG. 1 illustrates an exemplary Model-View-Controller environment according to some embodiments of the disclosed subject matter.

FIG. 2 illustrates an exemplary hierarchy of screens or pages according to some embodiments of the disclosed subject matter.

FIG. 3A illustrates arrangement of settings in a hierarchical fashion in a model file according to some embodiments of the disclosed subject matter.

FIG. 3B illustrates arrangement of settings in a flat structure in a model file according to some embodiments of the disclosed subject matter.

FIGS. 4A and 4B illustrate an exemplary user interface when a model is presented to users in a view, according to some embodiments of the disclosed subject matter.

FIG. 5 illustrates a visual design tool according to some embodiments of the disclosed subject matter.

FIG. 6 illustrates an exemplary method of managing data according to some embodiments of the disclosed subject matter.

FIG. 7 illustrates a block diagram of an exemplary computing device according to some embodiments of the disclosed subject matter.

### DETAILED DESCRIPTION

In the following description, numerous specific details are set forth regarding the systems and methods of the disclosed subject matter and the environment in which such systems and methods may operate, etc., in order to provide a thorough understanding of the disclosed subject matter. It will be apparent to one skilled in the art, however, that the disclosed subject matter may be practiced without such specific details, and that certain features, which are well known in the art, are not described in detail in order to avoid complication of the subject matter of the disclosed subject matter. In addition, it will be understood that the embodiments described below are only examples, and that it is contemplated that there are other systems and methods that are within the scope of the disclosed subject matter.

Various embodiments of the subject matter disclosed herein can provide more efficient and robust mechanisms for managing data. The techniques described herein can help reduce software development and maintenance time/cost, improve efficiency, enhance code re-usability, and improve consistency within an application/system or across multiple applications/systems.

A typical computer system or application generally has data associated with it. A common type of data is settings for the system or application. For example, a media player application can have a setting specifying the location (e.g., “D:\Documents\Music\”) where the media player should look for media files, and an alarm clock application can have a setting defining the default snooze length (e.g., 5 minutes). The application developer normally needs to write software code to handle the retrieval, display, updating, and/or storage of the setting.

In one exemplary embodiment, an application developer can separate application settings themselves from the presentation of the settings on a user interface. For example, the developer can separate what the application settings are (e.g., data defining that the snooze length is 5 minutes), from how they are shown to the users of the application (e.g., a slider control showing the user that the snooze length is 5 minutes). The application developer can create a model file containing descriptions of the application settings (e.g., what they are) and leave the retrieval, display, updating, and/or storage of the application settings to a separate module (e.g., a controller). A controller can (at runtime) load the model file, interpret the descriptions of the application settings in the model file, and present the settings to the users of the application. When a change is needed (e.g., a new setting is needed, an existing setting is no longer needed, or an existing setting is modified), the developer can simply update the model file itself. There is no need to rewrite or modify the code for the controller. The existing controller can load and interpret the updated model file and present the updated settings to the users. In some situations, a single controller can be re-used to interpret and present a large number of settings, which can be grouped into multiple screens/pages in a hierarchy. A single controller sometimes can also be re-used across multiple applications. The re-use of controllers can help maintain consistency in look-and-feel across multiple settings, pages/screens, or applications/systems.

For instance, in the example of a media player application mentioned above, the developer can create a model file containing the descriptions of data settings (e.g., “SearchFolder” for the location where the media player should search for media files) and create a separate controller file to handle the retrieval, display, updating, and storage of the data settings. When an additional data setting (e.g., “DefaultVolume”) is needed, the developer can simply update the model file to add the description for the new setting; there is no need to modify the controller. If the media player application has a large number of data settings, these data settings can be grouped into multiple hierarchical pages. For example, the configuration screen can start at a “General” setting page where one or more links can be embedded. The user can click on one of the links to go down to the next level of setting screens, which can also have one or more links to allow navigation further along the hierarchical chain. The single controller can be re-used to load and interpret the large number of data settings grouped into multiple hierarchical pages contained in the model file. There is no need to create a new controller or modify the existing controller.

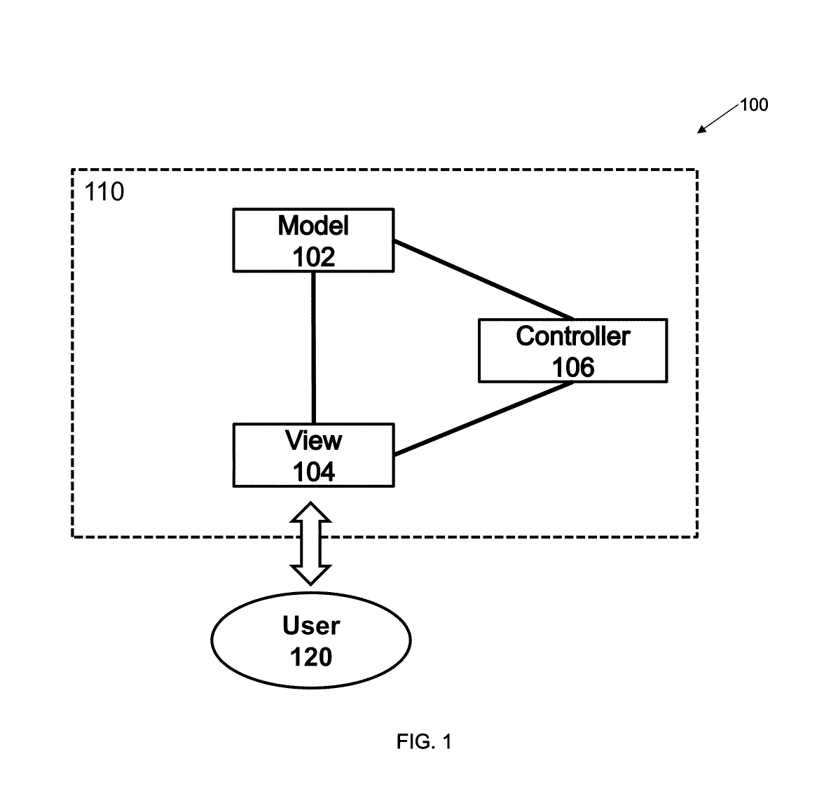

According to some embodiments of the disclosed subject matter, a Model-View-Controller (MVC) architecture is an architecture that separates the information itself from the presentation of the information and the user interaction with the presentation. FIG. 1 presents a diagram illustrating an exemplary Model-View-Controller environment 100. A MVC architecture 110 can contain a model 102, a view 104, and a controller 106. The model 102 can consist of the system/application data itself (e.g., settings). The view 104 can represent the presentation of the data (e.g., a checkbox on a setting screen/page). The controller 106 can manage the relationship between the model 102 and the view 104 (e.g., translating a checkbox toggling action on the user interface into an event to update the corresponding setting). In an exemplary operation, the model 102 can update the view 104 (e.g., via the controller 106) so that the view 104 can present the data in the model 102 to a user 120. The user 120 can interact with the MVC architecture 110 (e.g., via the view 104). The controller 106 can manipulate the associated model 102 according to the user's action. In one example, the controller 106 can send commands to the model 102 to update the model's state (e.g., editing a document); in another example, the controller 106 can also send commands to its associated view 104 to change the view's presentation of the model 102 (e.g., by scrolling through a document).

A MVC architecture like the one illustrated in FIG. 1 can help allow separation of concerns (SoC) and improve code reusability. In computer science, SoC generally refers to a design principle separating a computer program into distinct features that overlap in functionality as little as possible. A concern can be any piece of interest or focus in a program. Multiple views can be associated with a model. For example, a set of data can be presented in the format of a table or in the format of a graph to users; an “on/off” setting can be represented as a checkbox or a button. The model for a setting can be re-used and thus there is no need to create duplicative model code for a second view. A model can notify its associated view(s) and controller(s) when there has been a change in its state. The notification can allow the views to produce an updated output, and the controllers to change the available set of commands. A view can also request from the model the information that it needs to generate an output representation.

According to some embodiments of the disclosed subject matter, the content of the data (e.g., application settings) can be maintained in a model (e.g., 102 in FIG. 1). The model can be stored and maintained in a separate model file, which can contain information for each datum piece (e.g., each application setting). At runtime, the controller (e.g., 106 in FIG. 1) can load and interpret the model file to present the data contained in the model in a desired view (e.g., 104 in FIG. 1). The controller can also handle loading data (e.g., application settings) from or storing data to a transitory or non-transitory storage.

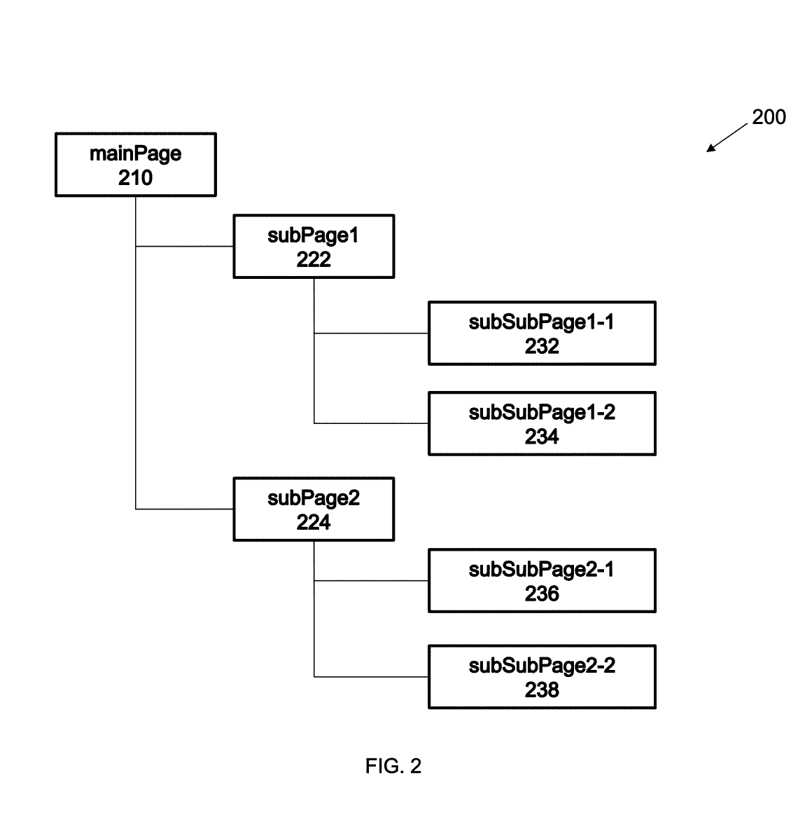

A model file can contain a large amount of data (e.g., a large number of application settings). Referring to FIG. 2, in some embodiments, the large number of settings can be grouped into multiple screens/pages in a hierarchical manner. The screen/page hierarchy can be visible when the settings are presented to users. For example, in an exemplary hierarchy of screens/pages 200, a user can start at the top/root of the hierarchy when he/she visits a mainPage 210, which can contain settings at the top level. From the mainPage 210, the user can navigate down one level along the hierarchical tree (e.g., by clicking a button or a link) to visit either subPage1 222 or subPage2 224, which can contain settings at the next level. From the subPage1 222, the user can further navigate down one level to visit settings contained in either subSubPage1-1 232 or subSubPage1-2 234. From the subPage2 224, the user can also further navigate down one level to visit settings contained in either subSubPage2-1 236 or subSubPage2-2 238.

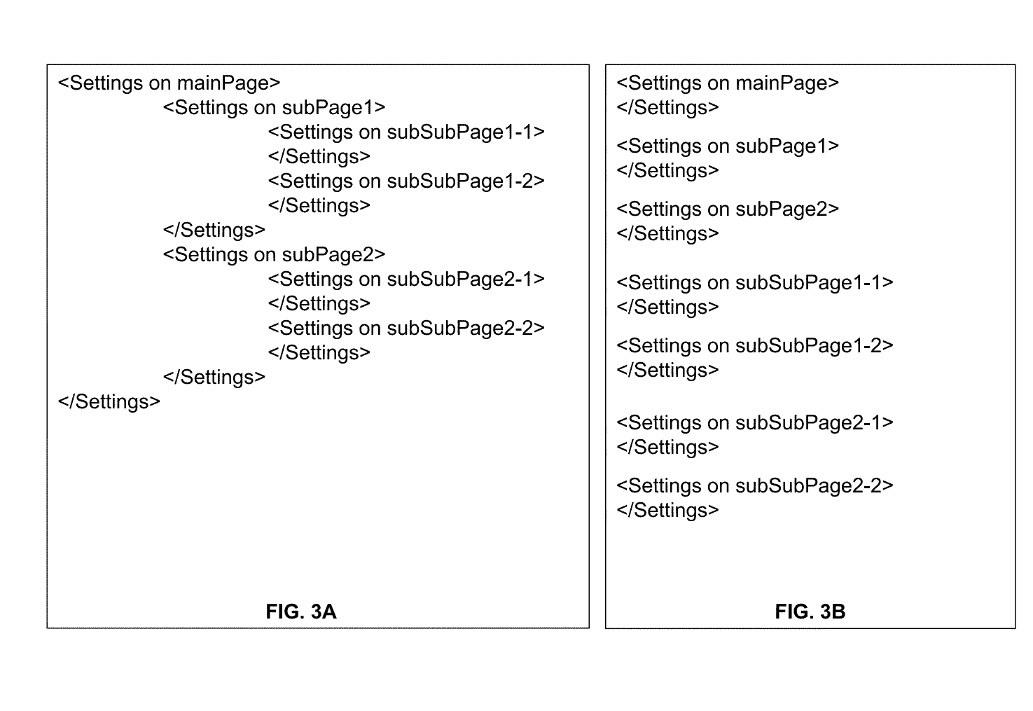

Referring to FIG. 3A, in one embodiment, the screen/page hierarchy can be maintained within the model file. Settings in a model file can be organized in a hierarchy fashion consistent with the corresponding screen/page hierarchy. Settings for subPage1 and subPage2 can be embedded within the settings for mainPage. Settings for subSubPage1-1 and subSubPage1-2 can be embedded within the settings for subPage1. Settings for subSubPage2-1 and subSubPage2-2 can be embedded within the settings for subPage2.

Referring to FIG. 3B, in another embodiment, the settings can be stored and maintained in the model file without the screen/page hierarchy. For example, as shown in FIG. 3B, settings in a model file can be organized in a flat structure. The settings for subPage1, subPage2, subSubPage1-1, subSubPage1-2, subSubPage2-1, and subSubPage2-2 can be all at the same top/root level as the settings for mainPage. A flat structure in a model file can help ease maintenance burden and improve flexibility. Settings can also be arranged in any order. In one example, settings for subPage1 can be listed before settings for subPage2 or before settings for mainPage. In another example, the setting(s) for a particular page/subpage can be referenced from any other setting regardless their groupings with respect to the screen/page hierarchy. In addition, a page can be linked to from any other page regardless of their positions in the screen/page hierarchy. For example, subSubPage2-1 can be referenced from within subPage1; mainPage can be launched from a UI control on subSubPage1-2.

In some embodiments, a model file can be in the format of a collection of dictionaries. In computer science, a dictionary (also known as an associative array) can refer to an abstract data type composed of a collection of key-value pairs, wherein each possible key appears at most once in the collection. An exemplary model file is listed in Appendix A. As shown, the dictionaries can contain either strings or arrays. Arrays themselves can contain dictionaries. When the settings in a model file are maintained in a flat structure (e.g., as illustrated in FIG. 3B), the model file can include at the root/top level one dictionary with a key (e.g., “mainPage,” “subPage1,” etc.) for every setting page. Each key can correspond to a dictionary value for that page. The main page (e.g., mainPage) can be the entry point for the settings in the model file. The key for the main page can be set by default or be customized by the application developer. In some situations, the key for a particular page (e.g., the main page) can be configured so that it matches the entry point key specified in the corresponding controller file.

In some embodiments, a page dictionary can contain a title and a section array of dictionaries. Each section dictionary can contain a title and an array of items for the section. Each item in the item array can be a dictionary that can contain the keys and string values. The string values stored in the dictionaries can correspond to a set of fixed keys. Some examples of fixed keys and their corresponding string values are listed in Table 1 below:

| Key | Corresponding String Value |
|---|---|
| “title” | Can be the display title for a settings page, a section, or an |
| | individual setting. For example: “Settings,” “Target,” |
| | “Test,” “Unlink Account,” or “There's More.” |
| “key” | Can be the name of the underlying setting or action associated |
| | with the UI control. |
| | For example: “targetID,” “username,” “unlink,” or “yesOrNo.” |
| | Can also be the reference to another page to be launched. |
| | For example: “subPage1.” |
| “type” | Can be one of |
| | “text”—a textbox, which can show the value of the setting |
| | referenced in the following “key” (e.g., “targetID”); |
| | “label”—a text field, which can show the value of the setting |
| | referenced in the following “key” (e.g., “username”); |
| | “disclosure”—a link to another page, which can be referenced |
| | in the following “key” (e.g. “subPage1”); |
| | “switch”—an On/Off switch, whose state can be associated |
| | with the setting referenced in the following “key” |
| | (e.g. “yesOrNo”); |
| | “button”—a push button, which can trigger the action |
| | referenced in the following “key” (e.g. “unlink”); or |
| | “check”—an item among multiple options, whose value can be |
| | stored in the following “key” (e.g. “100” or “200”). |
| “image” | (For a button) Can be a background image for a button. |
| | (for others) Can represent an optional image to the left of a title. |
| “url” | Can be a hyperlink to be opened (e.g., http:, mailto:, etc.). |

According to some embodiments of the disclosed subject matter, a controller can be written in source code from scratch or based on a standard code template. The source code of the controller can include the “wiring-up” of data (e.g., application settings) and their corresponding UI controls (e.g., buttons, textboxes, sliders, etc.) in the associated view. The controller can optionally control the layouts of the settings on the screens/pages and in some situations can dictate how the settings are presented in the view.

A controller can be written in various programming language (e.g., C/C++, Java, Object C, etc.). The Object C source code for an exemplary controller (e.g., “ASSettingsViewController.m”) is presented in Appendix B. The controller can set a default starting point, which can match one of the page keys in the corresponding mode file. For example: in the “initWithCoder” function as shown at line 19 in Appendix B.

self.currentPage=@“mainPage”; // set default to mainPage

The controller can also set up the page by loading data from the model file (e.g., a preference list file or a plist file). For example: in the “setupPage” function as shown at lines 29-32 in Appendix B,

```
NSString *path = [[NSBundle mainBundle] pathForResource:@“Settings”
                  ofType:@“plist”];
NSMutableDictionary* root = [[NSMutableDictionary alloc]
                                    initWithContentsOfFile:path];
```

At runtime, the model file can first be transformed into a binary format. The current page configured earlier can indicate which page to be selected first. Once the initial page is set, the title and the section array of dictionary can be loaded. For example, in the “setupPage” function as shown at lines 34-36 in Appendix B,

NSDictionary* currentPageDict = [root objectForKey:self.currentPage];
self.title = [currentPageDict objectForKey:@“title”];
self.sections = [currentPageDict objectForKey:@“sections”];

The controller can also support an optional “autofill” feature, e.g., as illustrated in the “setupPage” function as shown in Appendix B.

The controller can use an internal array to generate a dynamic list of key names and tag values, and then convert between key names and tag values when a user interacts with the controls in the user interface (e.g., clicks a button/switch). For example, in the “getTagForKey” and “getKeyForTag” functions as shown at lines 78-85 and 88-94 in Appendix B,

```
-(NSUInteger)getTagForKey:(NSString*)key{
    NSUInteger tag = [_keyTags indexOfObject:key];
    if (NSNotFound==tag) {
            [_keyTags addObject:key];
            tag = _keyTags.count − 1;
    }
    return tag;
}
-(NSString*)getKeyForTag:(NSUInteger)tag{
    NSString* key;
    if (tag < _keyTags.count) {
            key = [_keyTags objectAtIndex:tag];
    }
    return key;
}
```

In some embodiment, when a page refers to another page, a new view controller can be created by re-using the same controller code. For example, in the “table View” function as shown at lines 223-230 in Appendix B,

```
          if ([type isEqualToString:@“disclosure”]) { // create a new view controller and
                                re-use our controller code
            ASSettingsViewController *viewController = [self.storyboard
                      instantiateViewControllerWithIdentifier:@“settingsView”];
            [viewController setCurrentPage:[cellData objectForKey:@“key”]]; // the
new controller needs a reference
  [self.navigationController pushViewController:viewController
```

animated:YES];

}

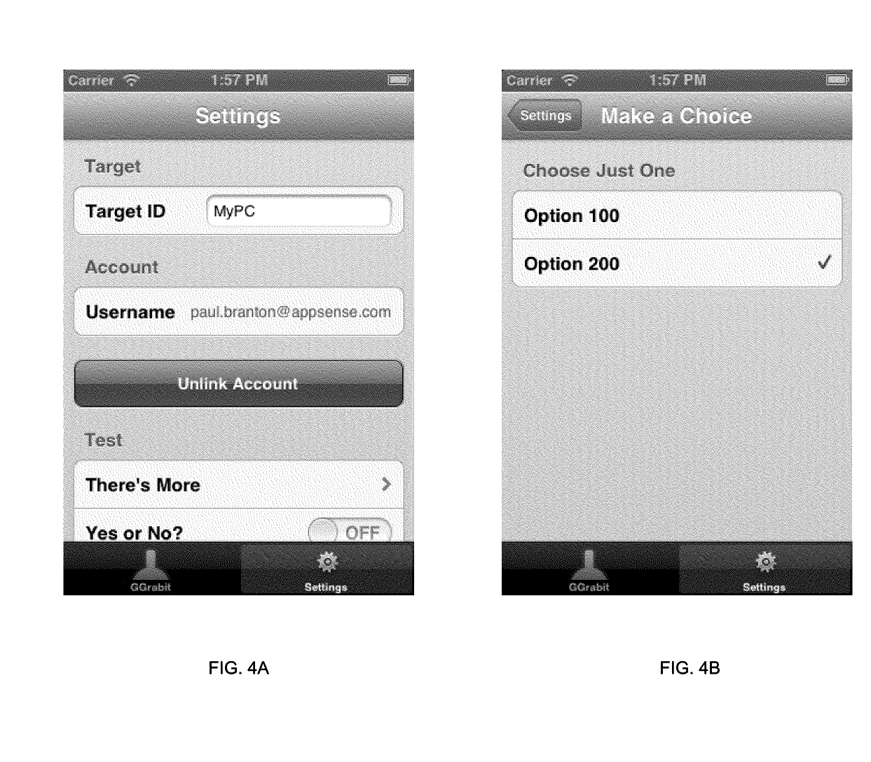

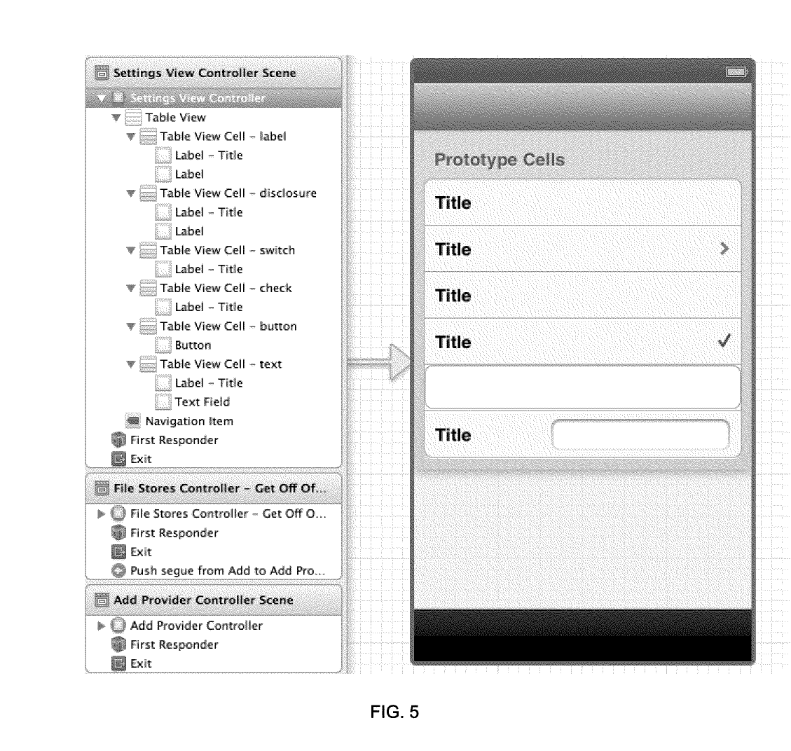

According to some embodiments of the disclosed subject matter, at runtime a controller can be executed to load a model file. The controller can interpret the model file and launch a corresponding view to present the data contained in the model file. FIGS. 4A-4B illustrate two pages/screens in an exemplary application user interface when the model file as illustrated in Appendix A is loaded and presented to the user. FIG. 4A illustrates an exemplary “mainPage” page, where the target ID can be set, the user name can be viewed, an unlink account action can be triggered, and a yes/no switch can be toggled. This figure represents a working example of how an embodiment of the disclosed subject matter can be used to present application settings in a typically iPhone user interface. A “subPage1” page can also be launched from the “mainPage” page when the “There's More” link is clicked. FIG. 4B illustrates an exemplary “subPage1” page, where two options (e.g., “Option 100” and “Option 200”) are available for selection. An application developer can also configure the layout of pages/screens and/or the desired view via an exemplary visual design tool, as illustrated in FIG. 5. As shown in FIG. 5, each cell type can have a corresponding layout. FIG. 5 demonstrates layouts for label, disclosure, switch, check, button, and text, etc. There can be any number of elements in each cell. Additional layout types can be added and catered for in the controller code.

According to the embodiments described herein, a large number of data (e.g., a large number of application settings) can be maintained and managed. The large number of settings can be grouped into multiple pages/screens, which can be organized in a hierarchy. The large number of settings, when stored in a model file, can be kept in a flat structure, which can be easier to maintain. A corresponding controller can automatically load the data (e.g., application settings) contained in the model file and present the data to a user in a view via the application's user interface. When a piece of datum (e.g., an application setting) needs to be added/removed/modified, an application developer may only need to update the model file; the same corresponding controller can then interpret the updated model file and present the new data to the user in a view. There is no need to update the source code file for the corresponding controller. This can help reduce application development time/cost and improve efficiency.

According to the embodiments described herein, the corresponding controller can be re-used for the large number of settings. For example, a single controller can be used for a large number of settings and screens/pages, even if these settings are grouped for multiple pages/screens; a single controller can be used regardless of the number of levels in the screen/page hierarchy. For example, the screen/page hierarchy can have two levels, e.g., mainPage and (subPage1 and subPage2); the screen/page hierarchy can have three levels, e.g., mainPage, (subPage1 and subPage2), and (subSubPage1-1, subSubPage1-2, subSubPage2-1, and subSubPage2-2); and the screen/page hierarchy can also have more than three levels. In these situations, there is no need for an application developer to re-write or modify the source code for the controller when a setting page/screen is added or removed or when a level is added to or removed from the screen/page hierarchy. This can reduce application development time/cost and improve efficiency, and also enhance code re-usability.

In addition, as discussed earlier, embodiments of the disclosed subject matter can allow re-use of pages at different locations. A page can be linked to from any other page regardless of their positions in the screen/page hierarchy. For example, subPage2 can be referenced from within subPage1 or mainPage.

The embodiments described herein can allow separation of data and the presentation thereof. In the situation of presenting a hierarchy of pages of settings, the relationship among the settings and/or among the pages can be defined or driven by the data in the model file. The controller can remain unchanged, minimizing the cost of system/application development and maintenance. In addition, the re-use of controllers can help maintain consistent look-and-feel across multiple screens/pages, and in some situations across multiple applications or systems.

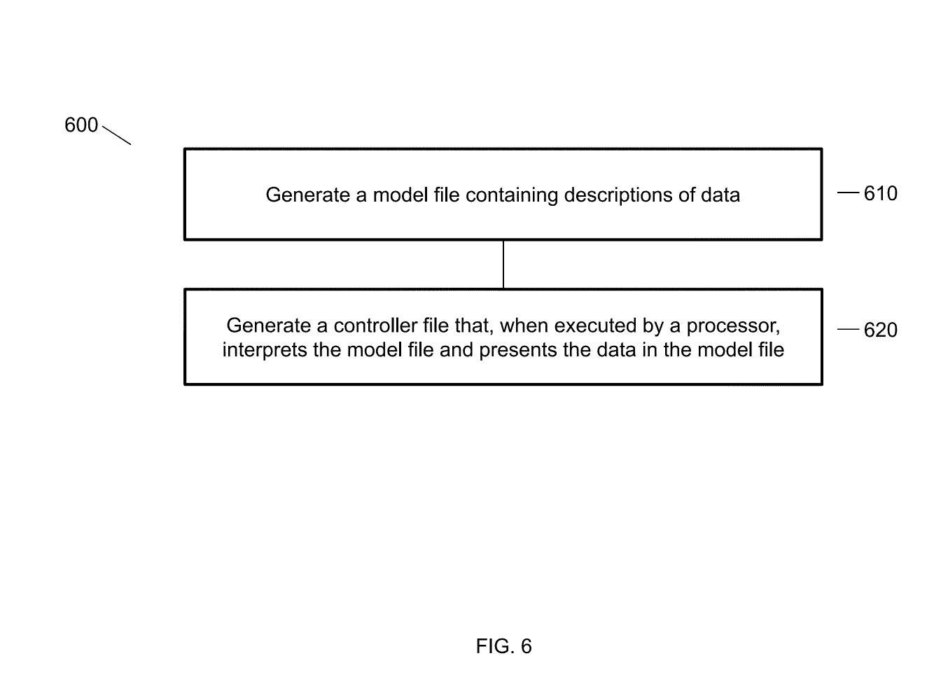

FIG. 6 illustrates an exemplary method of managing data according to some embodiments of the disclosed subject matter.

At stage 610, a model file can be generated which can contain descriptions of data. The data can be divided into multiple groups that are associated with multiple hierarchical pages. The data can include configuration settings of a computer application. The multiple hierarchical pages can have at least two levels. The descriptions of the data in the model file can be in a format of a collection of dictionaries. At least one dictionary in the collection of dictionaries can contain a string and an array. The multiple groups associated with the multiple hierarchical pages can be listed in the model file in a flat structure.

At stage 620, a controller file can be generated. The controller file, when executed by a processor, can interpret the model file and present the data in the multiple hierarchical pages to a user. The controller file can be re-used to interpret the descriptions of the data and present the data in the multiple hierarchical pages. The controller file, when executed by the processor, can also handle loading of the data from a storage medium and storing of the data to the storage medium. The controller file can include a reference to one of the multiple groups in the model file.

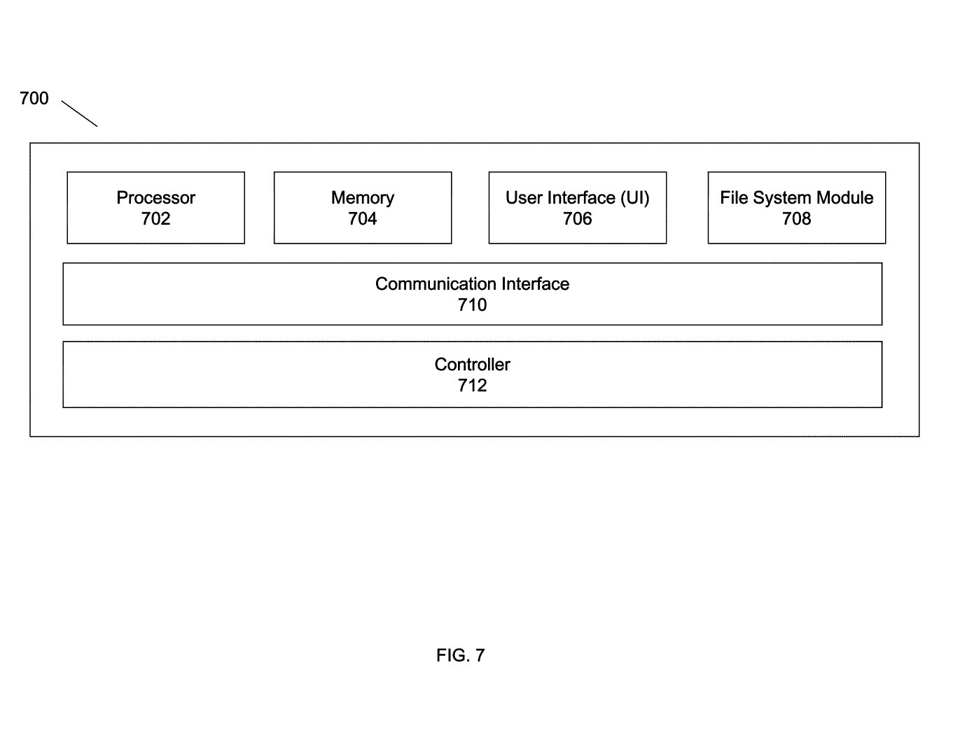

FIG. 7 illustrates a block diagram of a computing device that can be used to implement one or more aspects of the functionality described herein. The computing device 700 can include at least one processor 702 and at least one memory 704. The processor 702 can be hardware that is configured to execute computer readable instructions such as software. The processor 702 can be a general processor or be an application specific hardware (e.g., an application specific integrated circuit (ASIC), programmable logic array (PLA), field programmable gate array (FPGA), or any other integrated circuit). The processor 702 can execute computer instructions or computer code to perform desired tasks. The memory 704 can be a transitory or non-transitory computer readable medium, such as flash memory, a magnetic disk drive, an optical drive, a programmable read-only memory (PROM), a read-only memory (ROM), a random access memory (RAM), or any other memory or combination of memories.

The computing device 700 can also optionally include a user interface (UI) 706, a file system module 708, and a communication interface 710. The UI 706 can provide an interface for users to interact with the computing device 700 in order to access one or more aspects of the functionality described herein. The file system module 708 can be configured to maintain a list of all data files, including both local data files and remote data files, in every folder in a file system. The file system module 708 can be further configured to coordinate with the memory 704 to store and cache files/data. The communication interface 710 can allow the computing device 700 to communicate with external resources (e.g., a network or a remote client/server). The computing device 700 can also include a controller 712. The description of the controller 712 and its functionalities can be found in the discussion above. The controller 712 can be a separate module or can reside in the memory 704. The memory 704 can also contain one or more model files in one or more forms (e.g., source code format, and/or binary/executable format) as described above. The computer device 700 can include additional modules, fewer modules, or any other suitable combination of modules that perform any suitable operation or combination of operations.

In some embodiments, the disclosed subject matter can be implemented in many computing platforms, such as smartphones, tablets, Windows PC, and Mac OS systems, etc.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

A “server,” “client,” “agent,” “module,” “interface,” and “host” is not software per se and includes at least some tangible, non-transitory hardware that is configured to execute computer readable instructions.

APPENDIX A

| | |
|---|---|
| 1 | <?xml version=“1.0” encoding=“UTF-8” ?> |
| 2 | <!DOCTYPE plist (View Source for full doctype...)> |
| 3 | -<plist version=“1.0”> |
| 4 | -<dict> |
| 5 | <key>mainPage</key> |
| 6 | -<dict> |
| 7 | <key>title</key> |
| 8 | <string>Settings</string> |
| 9 | <key>sections</key> |
| 10 | -<array> |
| 11 | -<dict> |
| 12 | <key>title</key> |
| 13 | <string>Target</string> |
| 14 | <key>items</key> |
| 15 | -<array> |
| 16 | -<dict> |
| 17 | <key>title</key> |
| 18 | <string>Target ID</string> |
| 19 | <key>type</key> |
| 20 | <string>text</string> |
| 21 | <key>key</key> |
| 22 | <string>targetID</string> |
| 23 | </dict> |
| 24 | </array> |
| 25 | </dict> |
| 26 | -<dict> |
| 27 | <key>title</key> |
| 28 | <string>Account</string> |
| 29 | <key>items</key> |
| 30 | -<array> |
| 31 | -<dict> |
| 32 | <key>title</key> |
| 33 | <string>Username</string> |
| 34 | <key>type</key> |
| 35 | <string>label</string> |
| 36 | <key>key</key> |
| 37 | <string>username</string> |
| 38 | </dict> |
| 39 | </array> |
| 40 | </dict> |
| 41 | -<dict> |
| 42 | <key>items</key> |
| 43 | -<array> |
| 44 | -<dict> |
| 45 | <key>title</key> |
| 46 | <string>Unlink Account</string> |
| 47 | <key>type</key> |
| 48 | <string>button</string> |
| 49 | <key>key</key> |
| 50 | <string>unlink</string> |
| 51 | <key>image</key> |
| 52 | <string>back</string> |
| 53 | </dict> |
| 54 | </array> |
| 55 | </dict> |
| 56 | -<dict> |
| 57 | <key>title</key> |
| 58 | <string>Test</string> |
| 59 | <key>items</key> |
| 60 | -<array> |
| 61 | -<dict> |
| 62 | <key>title</key> |
| 63 | <string>There's More</string> |
| 64 | <key>type</key> |
| 65 | <string>disclosure</string> |
| 66 | <key>key</key> |
| 67 | <string>subPage1</string> |
| 68 | </dict> |
| 69 | -<dict> |
| 70 | <key>title</key> |
| 71 | <string>Yes or No?</string> |
| 72 | <key>type</key> |
| 73 | <string>switch</string> |
| 74 | <key>key</key> |
| 75 | <string>yesOrNo</string> |
| 76 | </dict> |
| 77 | </array> |
| 78 | </dict> |
| 79 | </array> |
| 80 | </dict> |
| 81 | <key>subPage1</key> |
| 82 | -<dict> |
| 83 | <key>title</key> |
| 84 | <string>Make a Choice</string> |
| 85 | <key>sections</key> |
| 86 | -<array> |
| 87 | -<dict> |
| 88 | <key>title</key> |
| 89 | <string>Choose Just One</string> |
| 90 | <key>items</key> |
| 91 | -<array> |
| 92 | -<dict> |
| 93 | <key>title</key> |
| 94 | <string>Option 100</string> |
| 95 | <key>type</key> |
| 96 | <string>check</string> |
| 97 | <key>key</key> |
| 98 | <string>100</string> |
| 99 | </dict> |
| 100 | -<dict> |
| 101 | <key>title</key> |
| 102 | <string>Option 200</string> |
| 103 | <key>type</key> |
| 104 | <string>check</string> |
| 105 | <key>key</key> |
| 106 | <string>200</string> |
| 107 | </dict> |
| 108 | </array> |
| 109 | </dict> |
| 110 | </array> |
| 111 | </dict> |
| 112 | </dict> |
| 113 | </plist> |

APPENDIX B

| | |
|---|---|
| 1 | // |
| 2 | // ASSettingsViewController.m |
| 3 | // |
| 4 | // |
| 5 | // Created by Paul Branton on 02/10/2012. |
| 6 | // Copyright (c) 2012 AppSense. All rights reserved. |
| 7 | // |
| 8 | #import “ASSettingsViewController.h” |
| 9 | #import <QuartzCore/QuartzCore.h> |
| 10 | #import “HelperMethods.h” |
| 11 | @interface ASSettingsViewController ( ) |
| 12 | @end |
| 13 | @implementation ASSettingsViewController |
| 14 | |
| 15 | //////////////////////////////////////////////////////////////////////////////////////////////////////// |
| 16 | −(id)initWithCoder:(NSCoder *)aDecoder{ |
| 17 | self = [super initWithCoder:aDecoder]; |
| 18 | if (self) { |
| 19 | self.currentPage = @“mainPage”; // set default to mainPage |
| 20 | _keyTags = [NSMutableArray array]; // our key to tag list |
| 21 | } |
| 22 | return self; |
| 23 | } |
| 24 | |
| 25 | //////////////////////////////////////////////////////////////////////////////////////////////////////// |
| 26 | // setup the page by loading the data from the plist file |
| 27 | // Dynamic Table item loading: Add a key for the autofill |
| 28 | −(void)setupPage{ |
| 29 | NSString *path = [[NSBundle mainBundle] pathForResource:@“Settings” |
| 30 | ofType:@“plist”]; |
| 31 | NSMutableDictionary* root = [[NSMutableDictionary alloc] |
| 32 | initWithContentsOfFile:path]; |
| 33 | // The current page tells us which dictionary to select from the root |
| 34 | NSDictionary* currentPageDict = [root objectForKey:self.currentPage]; |
| 35 | // Now we can set the title for the page |
| 36 | self.title = [currentPageDict objectForKey:@“title”]; |
| 37 | // The sections array will hold all the data we need for this page |
| 38 | self.sections = [currentPageDict objectForKey:@“sections”]; |
| 39 | for (NSMutableDictionary* dict in self.sections) { |
| 40 | NSString* autoFill = [dict objectForKey:@“key”]; |
| 41 | if (autoFill) { |
| 42 | NSMutableArray* items = [NSMutableArray array]; |
| 43 | for (ActiveProviderEntity* entity in [ActiveProviderEntity |
| 44 | getActiveProviderList]) { |
| 45 | NSDictionary* item = @{ |
| 46 | @“title” : entity.name, |
| 47 | @“type” : @“button”, |
| 48 | @“key” : [entity stringFromManagedObject] |
| 49 | }; |
| 50 | [items addObject:item]; |
| 51 | } |
| 52 | if ([items count]) { |
| 53 | dict setObject:items forKey:@“items”]; |
| 54 | } |
| 55 | } |
| 56 | } |
| 57 | } |
| 58 | |
| 59 | //////////////////////////////////////////////////////////////////////////////////////////////////////// |
| 60 | -(void)viewDidLoad{ |
| 61 | [super viewDidLoad]; |
| 62 | [self setupPage]; // get the correct data from the plist file and setup the title and |
| 63 | sections |
| 64 | } |
| 65 | |
| 66 | //////////////////////////////////////////////////////////////////////////////////////////////////////// |
| 67 | -(void)didReceiveMemoryWarning{ |
| 68 | [super didReceiveMemoryWarning]; |
| 69 | // Dispose of any resources that can be recreated. |
| 70 | } |
| 71 | |
| 72 | #pragma mark - Tag to/from Key |
| 73 | // These two functions use an internal array to create a dynamic list of key names and tag |
| 74 | values |
| 75 | // We can then convert between tag values and key names when a user click a button or a |
| 76 | switch |
| 77 | //////////////////////////////////////////////////////////////////////////////////////////////////////// |
| 78 | −(NSUInteger)getTagForKey:(NSString*)key{ |
| 79 | NSUInteger tag = [_keyTags indexOfObject:key]; |
| 80 | if (NSNotFound==tag) { |
| 81 | [_keyTags addObject:key]; |
| 82 | tag = _keyTags.count -1; |
| 83 | } |
| 84 | return tag; |
| 85 | } |
| 86 | |
| 87 | //////////////////////////////////////////////////////////////////////////////////////////////////////// |
| 88 | −(NSString*)getKeyForTag:(NSUInteger)tag{ |
| 89 | NSString* key; |
| 90 | if (tag < _keyTags.count) { |
| 91 | key = [_keyTags objectAtIndex:tag]; |
| 92 | } |
| 93 | return key; |
| 94 | } |
| 95 | |
| 96 | #pragma mark - Touch Handlers |
| 97 | //////////////////////////////////////////////////////////////////////////////////////////////////////// |
| 98 | −(void)buttonClicked:(id)sender{ |
| 99 | UIButton* button = sender; |
| 100 | NS String* key = [self getKeyForTag:button.tag]; |
| 101 | if (key) { |
| 102 | // do something with the button! |
| 103 | NSLog(@“You clicked %@”,key); |
| 104 | NSManagedObjectContext* context = [[ASJobCollectionManager |
| 105 | sharedInstance] mainObjectContext]; |
| 106 | NSManagedObject* entity = [key |
| 107 | managedObjectFromStringWithContext:context]; |
| 108 | if (entity) { |
| 109 | ActiveProviderEntity* provider = (ActiveProviderEntity*)entity; |
| 110 | [provider smokeTest]; |
| 111 | } |
| 112 | } |
| 113 | } |
| 114 | |
| 115 | //////////////////////////////////////////////////////////////////////////////////////////////////////// |
| 116 | −(void)switchClicked:(id)sender{ |
| 117 | UISwitch *switchview = sender; |
| 118 | NSString* key = [self getKeyForTag:switchview.tag]; |
| 119 | if (key) { |
| 120 | [HelperMethods setBoolViaUserDefaults:switchview.isOn forKey:key]; |
| 121 | } |
| 122 | } |
| 123 | |
| 124 | #pragma mark - Table view data source |
| 125 | //////////////////////////////////////////////////////////////////////////////////////////////////////// |
| 126 | -(NSInteger)numberOfSectionsInTableView:(UITableView *)tableView |
| 127 | { |
| 128 | // Return the number of sections. |
| 129 | return [self sections count]; |
| 130 | } |
| 131 | |
| 132 | //////////////////////////////////////////////////////////////////////////////////////////////////////// |
| 133 | -(NSInteger)tableView:(UITableView *)tableView |
| 134 | number0fRowsInSection:(NSInteger)section |
| 135 | { |
| 136 | // Return the number of rows in the section. |
| 137 | return [[[self sections objectAtIndex:section] objectForKey:@“items”] count]; |
| 138 | } |
| 139 | |
| 140 | //////////////////////////////////////////////////////////////////////////////////////////////////////// |
| 141 | −(NSString*)tableView:(UITableView *)tableView |
| 142 | titleForHeaderInSection:(NSInteger)section{ |
| 143 | return [[self sections objectAtIndex:section] objectForKey:@“title”]; |
| 144 | } |
| 145 | |
| 146 | //////////////////////////////////////////////////////////////////////////////////////////////////////// |
| 147 | -(UITableViewCell *)tableView:(UITableView *)tableView |
| 148 | cellForRowAtIndexPath:(NSIndexPath *)indexPath{ |
| 149 | // use indexPath to get the right section and the right row in that section |
| 150 | NSDictionary* cellData = [[[self.sections objectAtIndex:indexPath.section] |
| 151 | objectForKey:@“items”] objectAtIndex:indexPath.row]; |
| 152 | NSString* type = [cellData objectForKey:@“type”]; // we need to fetch the right cell |
| 153 | type (layout etc) |
| 154 | UITableViewCell *cell = [tableView dequeueReusableCellWithIdentifier:type |
| 155 | forIndexPath:indexPath]; |
| 156 | // Configure the cell... |
| 157 | NSString* title = [cellData objectForKey:@“title”]; |
| 158 | cell.textLabel.text = title; |
| 159 | cell.detailTextLabel.text = @“”; |
| 160 | NSString* key = [cellData objectForKey:@“key”]; |
| 161 | if ([type isEqualToString:@“label”]){ |
| 162 | [cell.textLabel setText:title]; |
| 163 | NSString* value = [HelperMethods getValueViaUserDefaults:key]; |
| 164 | if (value) { |
| 165 | [cell.detailTextLabel setText:value]; |
| 166 | } |
| 167 | // some labels might want a disclosure button (eg: if url is set) |
| 168 | if ([cellData objectForKey:@“url”]) { // NB. there may be others too. We |
| 169 | could check the name? |
| 170 | [cell |
| 171 | setAccessoryType:UITableViewCellAccessoryDisclosureIndicator]; |
| 172 | } |
| 173 | } |
| 174 | else if ([type isEqualToString:@“button”]){ |
| 175 | UIButton *button = (UIButton *)[cell viewWithTag:1]; |
| 176 | if ([button actionsForTarget:self |
| 177 | forControlEvent:UIControlEventTouchUpInside]==nil) { |
| 178 | button.tag = [self getTagForKey:key]; |
| 179 | [button addTarget:self action:@selector(buttonClick:) |
| 180 | forControlEvents:UIControlEventTouchUpInside]; |
| 181 | [button.layer setCornerRadius:8.0f]; |
| 182 | [button.layer setMasksToBounds:YES]; |
| 183 | [button.layer setBorderWidth:1.0f]; |
| 184 | NSString* background = [cellData objectForKey:@“image”]; |
| 185 | if (background) { |
| 186 | UIImage* backgroundImage = [UIImage |
| 187 | imageNamed:background]; |
| 188 | [button setBackgroundImage:backgroundImage |
| 189 | forState:UIControlStateNormal]; |
| 190 | } |
| 191 | } |
| 192 | [button setTitle:title forState:UIControlStateNormal]; |
| 193 | cell.textLabel.text = @“”; // no text for buttons |
| 194 | } |
| 195 | else if ([type isEqualToString:@“switch”]){ |
| 196 | UISwitch *switchview = [[UISwitch alloc] initWithFrame:CGRectZero]; |
| 197 | cell.accessoryView = switchview; |
| 198 | BOOL state = [HelperMethods getBoolViaUserDefaults:key]; |
| 199 | [switchview setOn:state]; |
| 200 | switchview.tag = [self getTagForKey:key]; |
| 201 | [switchview addTarget:self action:@selector(switchClicked:) |
| 202 | forControlEvents:UIControlEventValueChanged]; |
| 203 | } |
| 204 | else if ([type isEqualToString:@“check”]){ |
| 205 | NSString* currentSetting = [HelperMethods |
| 206 | getValueViaUserDefaults:self.currentPage]; |
| 207 | [cell setAccessoryType:([currentSetting |
| 208 | isEqualToString:key])?UITableViewCellAccessoryCheckmark:UITableViewCellAccessory |
| 209 | None]; |
| 210 | } |
| 211 | return cell; |
| 212 | } |
| 213 | |
| 214 | #pragma mark - Table view delegate |
| 215 | /////////////////////////////////////////////////////////////////////////////////////////////////////// |
| 216 | −(void)tableView:(UITableView *)tableView didSelectRowAtIndexPath:(NSIndexPath |
| 217 | *)indexPath { |
| 218 | NSDictionary* cellData = [[[self sections objectAtIndex:indexPath.section] |
| 219 | objectForKey:@“items”] objectAtIndex:indexPath.row]; |
| 220 | NSString* type = [cellData objectForKey:@“type”]; |
| 221 | NSString* urlString = [cellData objectForKey:@“url”]; |
| 222 | NSString* key = [cellData objectForKey:@“key”]; |
| 223 | if ([type isEqualToString:@“disclosure”]) { // create a new view controller |
| 224 | and re-use our controller code |
| 225 | ASSettingsViewController *viewController = [self storyboard |
| 226 | instantiateViewControllerWithIdentifier:@“settingsView”]; |
| 227 | [viewController setCurrentPage:[cellData objectForKey:@“key”]]; // the new |
| 228 | controller needs a reference |
| 229 | [self navigationController pushViewController:viewController |
| 230 | animated:YES]; |
| 231 | } |
| 232 | else if([type isEqualToString:@“check”]){ |
| 233 | [HelperMethods setValueViaUserDefaults:key forKey:self.currentPage]; |
| 234 | [self.tableView reloadData]; // need a reload after we have changed the value |
| 235 | } |
| 236 | else if (urlString){ |
| 237 | NSURL *url = [NSURL URLWithString:urlString]; |
| 238 | if (![[UIApplication sharedApplication] openURL:url]){ |
| 239 | NSLog(@“%@%@”,@“Failed to open url:”,[url description]); |
| 240 | } |
| 241 | } |
| 242 | } |
| 243 | |
| 244 | /////////////////////////////////////////////////////////////////////////////////////////////////////// |
| 245 | -(void)viewDidUnload { |
| 246 | [self setTableView:nil]; |
| 247 | [super viewDidUnload]; |
| 248 | } |
| 249 | @end |

What is claimed is:

1. A method of managing data, comprising:
generating a model file on a non-transitory computer readable medium containing descriptions of the data, wherein the descriptions of the data in the model file are formatted as a collection of dictionaries, wherein the descriptions of the data are divided into multiple groups that are associated with multiple hierarchical pages, and wherein the multiple groups associated with the multiple hierarchical pages are listed in the model file in a flat structure; and
generating a controller file on the non-transitory computer readable medium that, when executed by a processor, causes the processor to interpret the model file and present the data in the multiple hierarchical pages to a user, wherein the controller file refers to one of the multiple groups in the model file,
wherein the controller file is re-used to interpret the multiple groups in the descriptions of the data and present the data in the multiple hierarchical pages.

2. The method of claim 1, wherein the controller file refers to the one of the multiple groups in the model file by a key.

3. The method of claim 1, wherein the controller file, when executed by the processor, further causes the processor to handle loading of the data from a storage medium and storing of the data to the storage medium.

4. The method of claim 1, wherein at least one dictionary in the collection of dictionaries contains a string and an array.

5. The method of claim 1, wherein the multiple hierarchical pages have at least two levels.

6. A system for managing data, comprising:
a model file stored on a non-transitory computer readable medium containing descriptions of the data, wherein the descriptions of the data in the model file are formatted as a collection of dictionaries, wherein the descriptions of the data are divided into multiple groups that are associated with multiple hierarchical pages, and wherein the multiple groups associated with the multiple hierarchical pages are listed in the model file in a flat structure; and
a controller file stored on the non-transitory computer readable medium that, when executed by a processor, causes the processor to interpret the model file and present the data in the multiple hierarchical pages to a user, wherein the controller file refers to one of the multiple groups in the model file,
wherein the controller file is re-used to interpret the multiple groups in the descriptions of the data and present the data in the multiple hierarchical pages.

7. The system of claim 6, wherein the controller file refers to the one of the multiple groups in the model file by a key.

8. The system of claim 6, wherein the controller file, when executed by the processor, further handles loading of the data from a storage medium and storing of the data to the storage medium.

9. The system of claim 6, wherein the multiple hierarchical pages have at least two levels.

10. The system of claim 6, wherein at least one dictionary in the collection of dictionaries contains a string and an array.

11. A model file stored on a non-transitory computer readable medium for managing data, the model file comprising:
descriptions of the data formatted as a collection of dictionaries,
wherein the descriptions of the data are divided into multiple groups that are associated with multiple hierarchical pages in at least two levels,
wherein the multiple groups associated with the multiple hierarchical pages are listed in a flat structure, and
wherein, when interpreted by a controller at runtime, the model file causes the controller to:
present the data in the multiple hierarchical pages to a user,
interpret the multiple groups in the descriptions of the data for the multiple hierarchical pages in the at least two levels.

12. The model file of claim 11, wherein the controller refers to one of the multiple groups in the model file.

13. The method of claim 11, wherein at least one dictionary in the collection of dictionaries contains a string and an array.

14. A non-transitory computer readable medium having executable instructions that, when executed by a processor, cause the processor to:
load a model file containing descriptions of data, wherein the descriptions of the data in the model file are formatted as a collection of dictionaries, wherein the descriptions of the data are divided into multiple groups that are associated with multiple hierarchical pages, and wherein the multiple groups associated with the multiple hierarchical pages are listed in the model file in a flat structure; and
interpret the model file and present the data in the multiple hierarchical pages to a user,
wherein the executable instructions refer to one of the multiple groups in the model file, and
wherein the executable instructions are re-used to interpret the multiple groups in the model file and present the data in the multiple hierarchical pages.

15. The non-transitory computer readable medium of claim 14, wherein the executable instructions refer to the one of the multiple groups in the model file by a key.

16. The non-transitory computer readable medium of claim 14, wherein the executable instructions, when executed by the processor, further cause the processor to store at least a portion of the data in a storage medium.

17. The non-transitory computer readable medium of claim 14, wherein the multiple hierarchical pages have at least two levels.

18. The non-transitory computer readable medium of claim 14, wherein at least one dictionary in the collection of dictionaries contains a string and an array.
